(19) United States
(12) Patent Application Publication
(10) Pub. No.: US 2012/0297780 A1
(43) Pub. Date: Nov. 29, 2012

(54) ACTIVE FUEL TEMPERATURE CONTROL

(75) Inventors: Louis J. Bruno, Ellington, CT (US); Adam M. Finney, Rockford, IL (US)

(73) Assignee: HAMILTON SUNDSTRAND CORPORATION, Windsor Locks, CT (US)

(21) Appl. No.: 13/113,347

(22) Filed: May 23, 2011

(51) Int. Cl. F02C 7/14; F02C 7/224

(52) U.S. Cl. 60/772; 60/784; 60/785

(57) ABSTRACT

A system for managing fuel temperature in an engine includes a source of hot pressurized air and a turbine for converting hot pressurized air into cool expanded air. The system further includes a fuel tank for storing fuel, a fuel conduit fluidly connected to the fuel tank, and a first heat exchanger located on the fuel conduit. The first heat exchanger places the cool expanded air from the turbine in a heat exchange relationship with the fuel, thereby cooling the fuel.

### BACKGROUND

The present disclosure relates generally to fuel systems and more specifically, to methods and systems for managing fuel temperature.

Gas turbine engines typically include an inlet, a fan, a low pressure compressor, a high pressure compressor, a combustor, and at least one turbine. Air is pulled through the inlet and into the engine by the fan. Air is then compressed by the compressors and sent to the combustor, where the compressed air is mixed with fuel. The air/fuel mixture is ignited to generate combustion gases, which are channeled to one or more turbines. The turbine(s) extract energy from the combustion gases to power the compressors, as well as produce useful work (e.g. propel an aircraft).

Specific fuel consumption in a gas turbine engine is inversely proportional to the fuel temperature. Heat is commonly dumped from the engine oil system into the fuel system in order to cool the oil. An additional benefit is raising the temperature of the fuel and improving fuel efficiency for the engine. The fuel system also has a maximum temperature limit, which is often defined by coking in small fuel passages. A return to fuel tank conduit is typically employed to allow more fuel than required for combustion to flow and absorb heat from the system, thereby lowering the bulk temperature below the max allowable.

### SUMMARY

A system for managing fuel temperature includes a fuel tank for storing fuel and a return-to-tank fuel conduit fluidly connecting an outlet of the fuel tank with an inlet of the fuel tank. The system further includes a turbine for converting pressurized air into expanded air and a first heat exchanger located on the return-to-tank fuel conduit. The first heat exchanger places the expanded air from the turbine in a heat exchange relationship with the fuel, thereby cooling the fuel.

A system for managing fuel temperature in an engine includes a source of hot pressurized air and a turbine for converting hot pressurized air into cool expanded air. The system further includes a fuel tank for storing fuel, a fuel conduit fluidly connected to the fuel tank, and a first heat exchanger located on the fuel conduit. The first heat exchanger places the cool expanded air from the turbine in a heat exchange relationship with the fuel, thereby cooling the fuel.

A method for managing fuel temperature includes expanding a first portion of pressurized air to form expanded air, rejecting heat from fuel into the expanded air, thereby cooling the fuel, and flowing the cooled fuel into a fuel tank for later use by an engine.

### BRIEF DESCRIPTION OF THE DRAWINGS

FIG. 1 is a schematic flow chart depicting a fuel system in accordance with the prior art.

FIG. 2 is a schematic flow chart depicting a first embodiment of a fuel system in accordance with the present disclosure.

FIG. 3 is a schematic flow chart depicting a second embodiment of the fuel system in accordance with the present disclosure.

FIG. 4 is a schematic flow chart depicting a third embodiment of the fuel system in accordance with the present disclosure.

### DETAILED DESCRIPTION

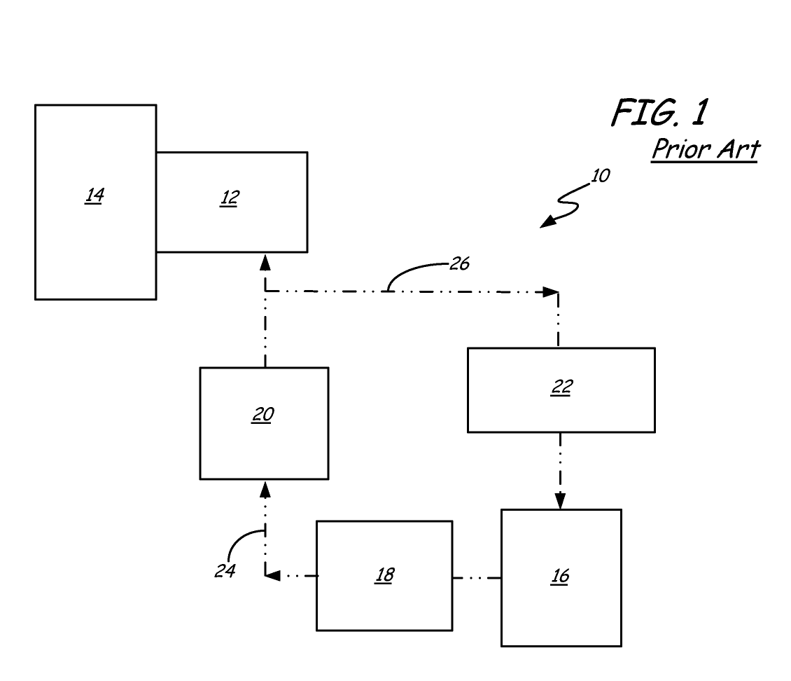

FIG. 1 is a schematic flow chart depicting fuel system 10 in accordance with the prior art. Shown in FIG. 1 are gas turbine engine 12, engine fan 14, and components of fuel system 10: tank 16, first heat exchanger 18, second heat exchanger 20, third heat exchanger 22, tank-to-engine conduit 24, and return-to-tank conduit 26. Fuel flows from tank 16 along tank-to-engine conduit 24 to provide fuel to a combustor of engine 12. A portion of fuel is diverted upstream of engine 12 and flows along return-to-tank conduit 26 back to tank 16 in order to manage fuel temperature in fuel system 10.

Fuel system 10 is representative of the prior art for thermal management of fuel in gas turbine engine 12 having fan 14. Tank 16, first heat exchanger 18, and second heat exchanger 20 are positioned along tank-to-engine conduit 24 in flow series. In other embodiments, first heat exchanger 18 and second heat exchanger 20 represent multiple heat exchangers and/or multiple heat loads. First heat exchanger 18 is located downstream of tank 16 and upstream of second heat exchanger 20 on tank-to-engine conduit 24. Second heat exchanger 20 is located downstream of first heat exchanger 18 and upstream of engine 12 on tank-to-engine conduit 24. Fuel for use by engine 12 is stored in tank 16. Fuel flows out of tank 16, along tank-to-engine conduit 24, and into first heat exchanger 18. First heat exchanger 18 transfers a heat load from an aircraft source (e.g. electronics, hydraulics, generators, environmental control system (ECS), fuel pumps, etc.) to the fuel, thereby increasing fuel temperature. Fuel exits first heat exchanger 18, flows along tank-to-engine conduit 24, and enters second heat exchanger 20. Second heat exchanger 20 transfers a heat load from an engine source (e.g. oil/lubrication, fueldraulic actuation, fuel pumps, etc.) to the fuel, thereby increasing fuel temperature. Fuel exits second heat exchanger 20, flows along tank-to-engine conduit 24, and enters engine 12 for use by a combustor. Accordingly, fuel temperature increases as it traverses tank-to-engine conduit 24 and approaches engine 12.

Third heat exchanger 22 and tank 16 are positioned along return-to-tank conduit 26 in flow series. Fuel flows from fuel-to-engine conduit 24 and into return-to-tank conduit 26 upstream of second-heat exchanger 20 and downstream of engine 12. Fuel flowing along return-to-tank conduit 26 enters third heat exchanger 22. Third heat exchanger 22 transfers a heat load from the fuel to an air source (e.g. ram air), thereby decreasing fuel temperature. Fuel exits third heat exchanger 22, flows along return-to-tank conduit 26, and back into tank 16. Accordingly, fuel temperature decreases as it traverses return-to-tank conduit 26 and approaches tank 16.

Each component of fuel system 10, as well as engine 12, specifies a maximum allowable fuel temperature. The maximum allowable fuel temperature determines the location of the specific component within fuel system 10. For example, first heat exchanger 18 has a lower maximum allowable fuel temperature than second heat exchanger 20 and therefore, first heat exchanger 18 is located upstream of second heat exchanger. As the temperature of fuel in fuel system 10 approaches a maximum allowable fuel temperature for any component, more fuel is pumped from tank 16 through fuel-to-engine conduit 24 to return-to-tank conduit 26. An increase in the amount of fuel diverted along return-to-tank conduit 26 can result in an increase in the average fuel temperature in tank 16, and therefore, the temperature of fuel throughout fuel system 10. This “passive” management of fuel temperature is problematic because high fuel temperatures induce more fuel recirculation, which results in ever increasing amounts of energy present within fuel system 10.

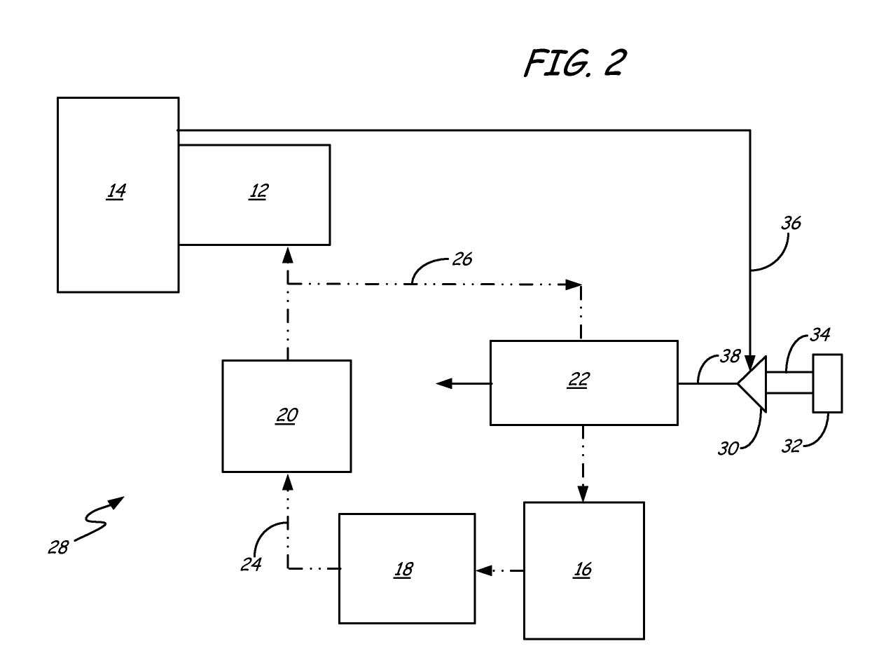

FIG. 2 is a schematic flow chart depicting a first embodiment of fuel system 28 in accordance with the present disclosure. Fuel system 28 contains many of the same components as fuel system 10 described above, and like numerals designate like components. Depicted in FIG. 2 are gas turbine engine 12, fan 14, and components of fuel system 28: tank 16, first heat exchanger 18, second heat exchanger 20, third heat exchanger 22, tank-to-engine conduit 24, and return-to-tank conduit 26. Also shown are turbine 30, energy absorber 32, shaft 34, pressurized air conduit 36, and expanded air conduit 38. Third heat exchanger 22 cools fuel with expanded air from turbine 30. In the example, the turbine 30 is independent from a turbine section within the gas turbine engine 12.

A portion of fuel system 28 is similar to fuel system 10 described above with respect to FIG. 1. Tank 16, first heat exchanger 18, and second heat exchanger 20 are positioned along tank-to-engine conduit 24 in flow series. Third heat exchanger 22 and tank 16 are positioned along return-to-tank conduit 26 in flow series. For the sake of brevity, the location and function of these similar components is not repeated here. In contrast to fuel system 10 described above, fuel system 28 includes turbine 30 for providing expanded air to third heat exchanger 22.

Turbine 30 is attached to energy absorber 32 (e.g. generator, compressor, fan, etc.) by shaft 34. Pressurized air conduit 36 connects a source of pressured air (e.g. fan, ram, bleed, etc.) to an inlet of turbine 30, and expanded air conduit 38 connects an outlet of turbine 30 to third heat exchanger 22. Pressurized air is conducted from its source to turbine 30 along pressurized air conduit 36. Within turbine 30, the hot pressurized air is expanded and cooled. The expansion of air within turbine 30 generates rotational energy, which is transferred to energy absorber 32 by shaft 34. Expanded air is conducted from turbine 30 to third heat exchanger 22 by expanded air conduit 38. Within third heat exchanger 22, heat is dumped from the fuel to the expanded air, which is then dumped overboard or sent to another system for use. Third heat exchanger 22 actively cools (or removes heat from) the fuel in order to reduce fuel temperature before it flows back to tank 16. Since expanded air from turbine 30 (“active” air) is significantly cooler than ram air (“passive” air), third heat exchanger 22 of fuel system 28 provides a much more effective heat sink for fuel than third heat exchanger 22 of fuel system 10.

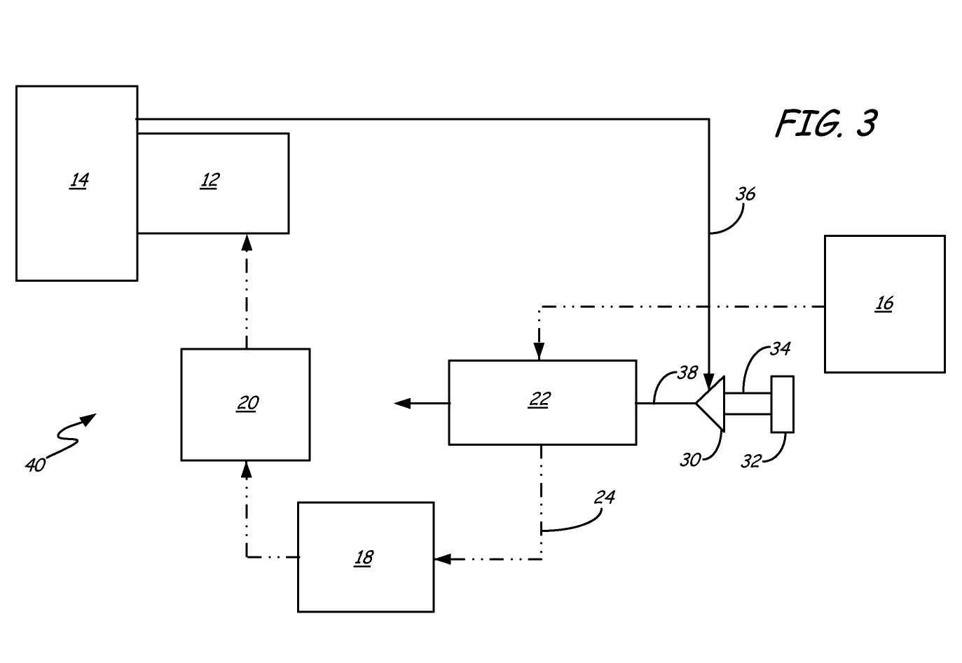

FIG. 3 is a schematic flow chart depicting a second embodiment of fuel system 40 in accordance with the present disclosure. Fuel system 40 contains many of the same components as fuel systems 10 & 28 described above, and like numerals designate like components. Depicted in FIG. 3 are gas turbine engine 12, fan 14, and components of fuel system 40: tank 16, first heat exchanger 18, second heat exchanger 20, third heat exchanger 22, and tank-to-engine conduit 24. Also shown are turbine 30, energy absorber 32, shaft 34, pressurized air conduit 36, and expanded air conduit 38. Third heat exchanger 22, which is located on tank-to-engine conduit 24, actively cools fuel with expanded air from turbine 30.

Components of fuel system 40 are similar to components of fuel systems 10 & 28 described above, but are arranged in a different order to negate the need for return-to-tank conduit (item 26 in FIGS. 2 & 3). Tank 16, third heat exchanger 22, first heat exchanger 18, and second heat exchanger 20 are positioned along tank-to-engine conduit 24 in flow series. Accordingly, third heat exchanger 22 is located downstream of tank 16 and upstream of first heat exchanger 18. Fuel flows from tank 16, through tank-to-engine conduit 24, and into third exchanger 22. As described above for fuel system 28, pressurized air conduit 36 connects a source of pressured air to an inlet of turbine 30, and expanded air conduit 38 connects an outlet of turbine 30 to third heat exchanger 22. Within third heat exchanger 22, fuel is placed in a heat exchange relationship with expanded air from turbine 30. Heat from the fuel is absorbed by the expanded air, such that fuel exits third heat exchanger 22 at a lower temperature than it entered third exchanger 22. Fuel continues along tank-to-engine conduit 24 to absorb a heat load from an aircraft (within first heat exchanger 18), and absorb a heat load from the engine 12 (within second heat exchanger 20), as described above for fuel systems 10 & 28. Fuel system 40 actively cools fuel with expanded air in third heat exchanger 22 to pre-cool fuel, thereby allowing for a greater temperature difference between fuel and heat loads in first and second heat exchangers 18 & 20. The architecture of fuel system 40 actively modulates the cooling in third heat exchanger 22 to ensure no temperature limits are exceeded and eliminates the need for a return-to-tank conduit (item 26 in FIGS. 2 & 3).

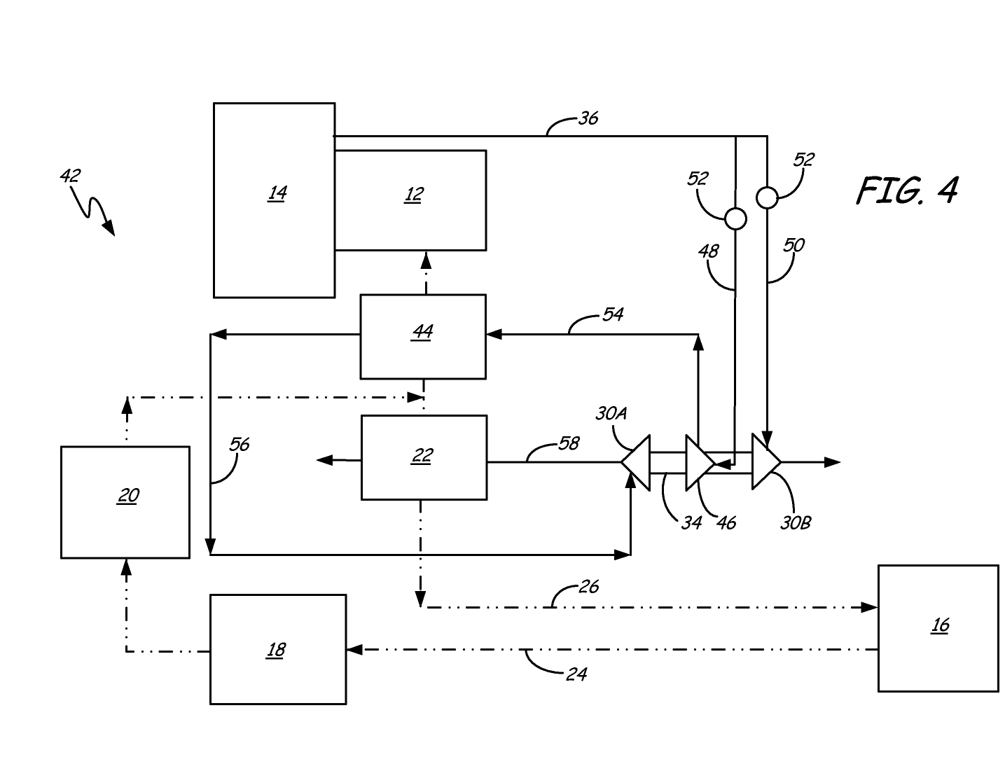

FIG. 4 is a schematic flow chart depicting a third embodiment of fuel system 42 in accordance with the present disclosure. Fuel system 42 contains many of the same components as fuel systems 10, 28, & 40 described above, and like numerals designate like components. Depicted in FIG. 4 are gas turbine engine 12, fan 14, and components of fuel system 42: tank 16, first heat exchanger 18, second heat exchanger 20, third heat exchanger 22, tank-to-engine conduit 24, return-to-engine conduit 26, and fourth heat exchanger 44. Also shown are first and second turbines 30A & 30B, shaft 34, pressurized air conduit 36, compressor 46, first branch air conduit 48, second branch air conduit 50, valves 52, compressed air conduit 54, return air conduit 56, and expanded air conduit 58. Fuel exiting second heat exchanger 20 either is heated by fourth heat exchanger 44 prior to use by engine 12 or cooled by third heat exchanger 22 prior to returning to tank 16.

Components of fuel system 42 are similar to components of fuel systems 10, 28, & 40 described above. Tank 16, first heat exchanger 18, and second heat exchanger 20 are positioned along tank-to-engine conduit 24 in flow series. Third heat exchanger 22 and tank 16 are positioned along return-to-tank conduit 26 in flow series. Fourth heat exchanger 44 is located downstream of second heat exchanger 20 and upstream of both engine 12. As fuel exits second heat exchanger 22, it is either heated by fourth heat exchanger 44 and sent to engine 12 for use, or cooled by third heat exchanger 22 and sent back to tank 16 via return-to-tank conduit 26.

Pressurized air conduit 36 provides a source of pressured air for use by both third heat exchanger 22 and fourth heat exchanger 44. Pressurized air conduit 36 connects a source of pressurized air (e.g. ram, fan, bleed, etc.) with both first branch air conduit 48 and second branch air conduit 50, each having valve 52. Second branch air conduit 50 directs pressurized air to second turbine 30B, where it is expanded and sent to cool a heat load or exhausted overboard. First branch air conduit 48 directs pressurized air to compressor 46 for use by fourth heat exchanger 44 and subsequently, to first turbine 30A for use by third heat exchanger 22. Accordingly, fuel system 42 includes a three-cycle air machine (including first turbine 30A, second turbine 30B, and compressor 46) and third and fourth heat exchangers 22 & 44 to better modulate fuel temperature within fuel system 42.

Pressurized air from first branch air conduit 48 enters compressor 46, and is compressed. This compressed air exits compressor 46 and is sent through compressed air conduit 54 to fourth heat exchanger 44. Within fourth heat exchanger 44, compressed air is placed in a heat exchange relationship with fuel, thereby increasing fuel temperature. After dumping heat into the fuel, compressed air exits fourth heat exchanger 44 and travels along return air conduit 56 to first turbine 30A. Compressed air is subsequently expanded within first turbine 30A, and the extracted energy is sent along shaft 34 to compressor 46 for use, where compressor 46 is attached to first turbine 30A and optionally second turbine 30B by shaft 34. (Compressor 46 can also be powered, in part, by second turbine 30B.) Expanded air exits first turbine 30A and is directed along expanded air conduit 58 to third heat exchanger 22. Within third heat exchanger 22, fuel is placed in a heat exchange relationship with expanded air. Heat from the fuel is absorbed by the expanded air, thereby decreasing the fuel temperature. After use by third heat exchanger 22, expanded air is exhausted overboard or sent to cool another heat load. Fuel exits third heat exchanger 22 and is sent back to tank 16 via return-to-tank conduit 26.

Fuel system 42 uses a pressurized air source, a three-wheel air cycle machine, and third and fourth heat exchangers 22 & 44 to better manage fuel temperature across a mission. Pressurized air is sent to compressor 46 for compression, and then fourth heat exchanger 44 to increase fuel temperature prior to use by engine 12. Air exiting fourth heat exchanger 44 is sent to first turbine 30A for expansion, and then third heat exchanger 22 to decrease fuel temperature prior to storage in tank 16. Fuel system 42 provides the flexibility to sub-cool fuel and actively control fuel temperature for gas turbine engine 12, which is absent in prior art systems.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system for managing fuel temperature, the system comprising:
a fuel tank for storing fuel;
a return-to-tank fuel conduit fluidly connecting an outlet of the fuel tank with an inlet of the fuel tank;
a turbine for converting pressurized air into expanded air; and
a first heat exchanger located on the return-to-tank fuel conduit, the first heat exchanger placing the expanded air from the turbine in a heat exchange relationship with the fuel, thereby cooling the fuel.

2. The system of claim 1, further comprising:
a fuel-to-engine fuel conduit fluidly connecting the fuel tank to an engine; and
a second heat exchanger located on the fuel-to-engine fuel conduit, the second heat exchanger placing an aircraft heat load in a heat exchange relationship with the fuel, thereby heating the fuel.

3. The system of claim 2, further comprising:
a third heat exchanger on the fuel-to-engine fuel conduit, the third heat exchanger placing an engine heat load in a heat exchange relationship with the fuel, thereby heating the fuel.

4. The system of claim 3, wherein the third heat exchanger is downstream of the second heat exchanger.

5. The system of claim 4, wherein the return-to-tank conduit is connected to the fuel-to-engine fuel conduit downstream of the third heat exchanger and upstream of the engine.

6. The system of claim 5, further comprising:
a fourth heat exchanger on the fuel-to-engine fuel conduit downstream of the third heat exchanger, the fourth heat exchanger placing compressed air in a heat exchange relationship with the fuel, thereby heating the fuel.

7. The system of claim 6, further comprising:
a compressor attached to the turbine, the compressor providing the compressed air for heating the fuel within the fourth heat exchanger.

8. The system of claim 7, further comprising:
a second turbine attached to the compressor.

9. A system for managing fuel temperature in an engine, the system comprising:
a source of hot pressurized air;
a turbine for converting hot pressurized air into cool expanded air;
a fuel tank for storing fuel;
a fuel conduit fluidly connected to the fuel tank; and
a first heat exchanger located on the fuel conduit, the first heat exchanger placing the cool expanded air from the turbine in a heat exchange relationship with the fuel, thereby cooling the fuel.

10. The system of claim 9, wherein the first heat exchanger is upstream of the fuel tank.

11. The system of claim 9, wherein the first heat exchanger is downstream of the fuel tank.

12. The system of claim 11, further comprising:
a second heat exchanger located on the fuel conduit downstream of the first heat exchanger, the second heat exchanger placing an aircraft heat load in a heat exchange relationship with the fuel, thereby heating the fuel.

13. The system of claim 12, further comprising:
a third heat exchanger on the fuel conduit downstream of the second heat exchanger, the third heat exchanger placing an engine heat load in a heat exchange relationship with the fuel, thereby heating the fuel.

14. The system of claim 13, further comprising:
a fourth heat exchanger on the fuel conduit downstream of the third heat exchanger, the fourth heat exchanger placing compressed air in a heat exchange relationship with the fuel, thereby heating the fuel.

15. The system of claim 14, further comprising:
a compressor attached to the turbine, the compressor providing the compressed air for heating the fuel within the fourth heat exchanger.

16. The system of claim 9, wherein the hot pressurized air is one of ram air, fan air, or bleed air.

17. A method for managing fuel temperature, the method comprising:
expanding a first portion of pressurized air to form expanded air;
rejecting heat from fuel into the expanded air, thereby cooling the fuel; and
flowing the cooled fuel into a fuel tank for later use by an engine.

18. The method of claim 17, further comprising:
rejecting an aircraft heat load into the fuel, thereby heating the fuel; and
flowing the heated fuel into the engine for use.

19. The method of claim 18, further comprising:
rejecting an engine heat load into the fuel, thereby heating the fuel.

20. The method of claim 19, further comprising:
compressing a second portion of pressurized air to form compressed air; and
rejecting heat from the compressed air into the fuel, thereby heating the fuel.

21. The method of claim 20, wherein a compressor compresses the second portion of pressurized air and a turbine expands the first portion of pressurized air, the compressor and the turbine are connected to one another.
